(19) United States
(12) Patent Application Publication
(10) Pub. No.: US 2026/0085966 A1
(43) Pub. Date: Mar. 26, 2026

(54) METHODS AND APPARATUS TO ESTIMATE WEIGHT OF A VEHICLE

(71) Applicant: Ford Global Technologies, LLC, Dearborn, MI (US)

(72) Inventors: Christian Thomas Bach, Wolverine Lake, MI (US); Jorge Rivas, Northville, MI (US); Rafael Cicogna Santos, Royal Oak, MI (US); Ethan Richard Kaese, Keego Harbor, MI (US); Laith Faris Saleh Dababneh, Canton, MI (US)

(21) Appl. No.: 18/891,865

(22) Filed: Sep. 20, 2024

(51) Int. Cl. G01G 19/12; G01G 23/37

(52) U.S. Cl. CPC G01G 19/12; G01G 23/3728

(57) ABSTRACT

Methods and apparatus to estimate weight of a vehicle are disclosed. An example apparatus includes at least one processor circuit to obtain strain measurement data from a strain gauge, the strain gauge coupled to a surface of a shock tower of a vehicle, estimate, based on the strain measurement data, a gross vehicle weight of the vehicle, and output the gross vehicle weight for presentation by a user interface.

### FIELD OF THE DISCLOSURE

This disclosure relates generally to vehicles and, more particularly, to methods and apparatus to estimate weight of a vehicle.

### BACKGROUND

Some vehicles (e.g., vans, trucks, sports utility vehicles (SUVs), etc.) can carry significant loads and often have weight limits that should not be exceeded to ensure proper vehicle handling and/or performance during normal use

### SUMMARY

An example apparatus disclosed herein includes interface circuitry, machine-readable instructions, and at least one processor circuit to be programmed by the machine-readable instructions to obtain strain measurement data from a strain gauge, the strain gauge coupled to a surface of a shock tower of a vehicle, and estimate, based on the strain measurement data, a gross vehicle weight of the vehicle.

At least one example non-transitory machine-readable medium disclosed herein includes machine-readable instructions to cause at least one processor circuit to at least obtain strain measurement data from a strain gauge, the strain gauge coupled to a surface of a shock tower of a vehicle, and estimate, based on the strain measurement data, a gross vehicle weight of the vehicle.

An example method disclosed herein includes obtaining strain measurement data from a strain gauge, the strain gauge coupled to a surface of a shock tower of a vehicle, and estimating, based on the strain measurement data, a gross vehicle weight of the vehicle.

### BRIEF DESCRIPTION OF THE DRAWINGS

FIG. 1 illustrates an example vehicle implementing example vehicle weight estimation circuitry in accordance with teachings of this disclosure.

FIG. 2 is a perspective view of an example shock tower that may be implemented on the example vehicle of FIG. 1.

FIG. 3 illustrates a first example mounting location for a strain gauge on an example shock tower.

FIG. 4 illustrates a second example mounting location for the strain gauge on the shock tower of FIG. 3.

FIG. 5 is a top view of the shock tower of FIGS. 3 and/or 4 with additional example mounting locations shown.

FIG. 6 illustrates a sixth example mounting location for the strain gauge on the shock tower of FIGS. 3, 4, and/or 5.

FIG. 7 illustrates the example shock tower of FIGS. 3, 4, 5, and/or 6 including example mounting blocks.

FIG. 8 illustrates the example shock tower including the mounting blocks of FIG. 7, with strain gauges coupled to respective ones of the mounting blocks.

FIG. 9 is a block diagram of an example implementation of the example vehicle weight estimation circuitry of FIG. 1.

FIG. 10 illustrates an example plot representative of example data samples corresponding to one of the wheels of FIG. 1.

FIG. 11A illustrates a first example graph representative of example estimated corner weights and corresponding example measured corner weights obtained and/or determined for a respective one of the wheels of FIG. 1.

FIG. 11B illustrates a second example graph representative of example hysteresis analysis results corresponding to selected corner weight values from FIG. 11A.

FIG. 11C illustrates a third example graph representative of error between the estimated corner weights and the corresponding measured corner weights of FIGS. 11A and/or 11B.

FIG. 12 is a flowchart representative of example machine readable instructions and/or example operations that may be executed, instantiated, and/or performed by programmable circuitry to estimate one or more example weight metric(s) associated with the vehicle of FIG. 1.

FIG. 13 is a flowchart representative of example machine readable instructions and/or example operations that may be executed, instantiated, and/or performed by programmable circuitry to generate one or more example calibration models.

FIG. 14 is a block diagram of an example programmable circuitry platform structured to execute and/or instantiate the example machine-readable instructions and/or the example operations of FIGS. 12 and/or 13 to implement the vehicle weight estimation circuitry of FIG. 9.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

As used herein, the orientation of features is described with reference to a lateral axis, a vertical axis, and a longitudinal axis of the vehicle associated with the features. As used herein, the longitudinal axis of the vehicle is parallel to a centerline of the vehicle. The terms “rear” and “front” are used to refer to directions along the longitudinal axis closer to the rear of the vehicle and the front of the vehicle, respectively. As used herein, the vertical axis of the vehicle is perpendicular to the ground on which the vehicle rests. The terms “below” and “above” are used to refer to directions along the vertical axis closer to the ground and away from the ground, respectively. As used herein, the lateral axis of the vehicle is perpendicular to the longitudinal and vertical axes and is generally parallel to the axles of the vehicle.

As used herein, “gross vehicle weight” (GVW) refers to the weight of a vehicle (e.g., a curb weight of the vehicle in addition to the weight of any cargo and/or passengers on the vehicle). As used herein, the “load weight” on a vehicle refers to the difference between the gross vehicle weight and the curb weight of the vehicle (e.g., where the curb weight corresponds to the weight of the vehicle hardware and consumables, the weight of the vehicle including a full tank of fuel and standard equipment but without passengers or cargo, etc.). The load weight on a vehicle typically includes the weight added by a user of a vehicle (e.g., the weight of the passengers of the vehicle, cargo loaded in the vehicle, etc.). As used herein, a “gross vehicle weight rating” (GVWR) refers to a maximum allowable gross vehicle weight of the vehicle (e.g., a maximum allowable weight of the vehicle when loaded with passengers and/or cargo). As used herein, a “corner weight” refers to a weight of the vehicle carried by a respective wheel of the vehicle.

Some techniques for estimating vehicle weight and/or load weight rely on the use of designated load sensors on the vehicle, which may necessitate an increase in weight associated with the vehicle. Alternatively, some known techniques measure suspension position and/or displacement to estimate vehicle weight and/or load weight. In some instances, noise may be introduced to such suspension-based measurements as a result of hysteresis in one or more springs of a suspension system, sagging of the suspension system, bushing windup, energy loss and/or gain at one or more joints of the suspension system, camber gain, park brake-induced rigidness in the suspension system, etc. Such noise may reduce accuracy and/or consistency of measurements associated with the suspension system and, as a result, may reduce accuracy of load weight and/or vehicle weight estimations based on the measurements.

Examples disclosed herein utilize one or more strain gauges (e.g., strain sensors) coupled to respective shock towers of a vehicle to measure strain resulting from deformation of the shock tower(s) under load.

Based on measurement data (e.g., strain measurements) from the strain gauge(s), disclosed examples estimate a load weight on the vehicle, a GVW of the vehicle, and/or one or more corner weights associated with respective wheels of the vehicle. In some examples, strain gauges are robust to changes in temperature and, as such, measurement data from the strain gauges may be more resistant to noise (e.g., compared to measurement data from a position sensor and/or a different type of sensor). Additionally, by mounting the strain gauges on a shock tower, examples disclosed herein utilize a primary vertical load path of a suspension spring associated with the shock tower to obtain measurable (e.g., sufficiently large) and consistent strain measurements. By utilizing data from strain gauges mounted on respective shock towers of the vehicle, examples disclosed herein can provide vehicle weight and/or load weight estimates that are resistant to suspension-based noise factors and, as a result, may be more accurate and reliable (e.g., compared to estimates obtained using some known load estimation techniques).

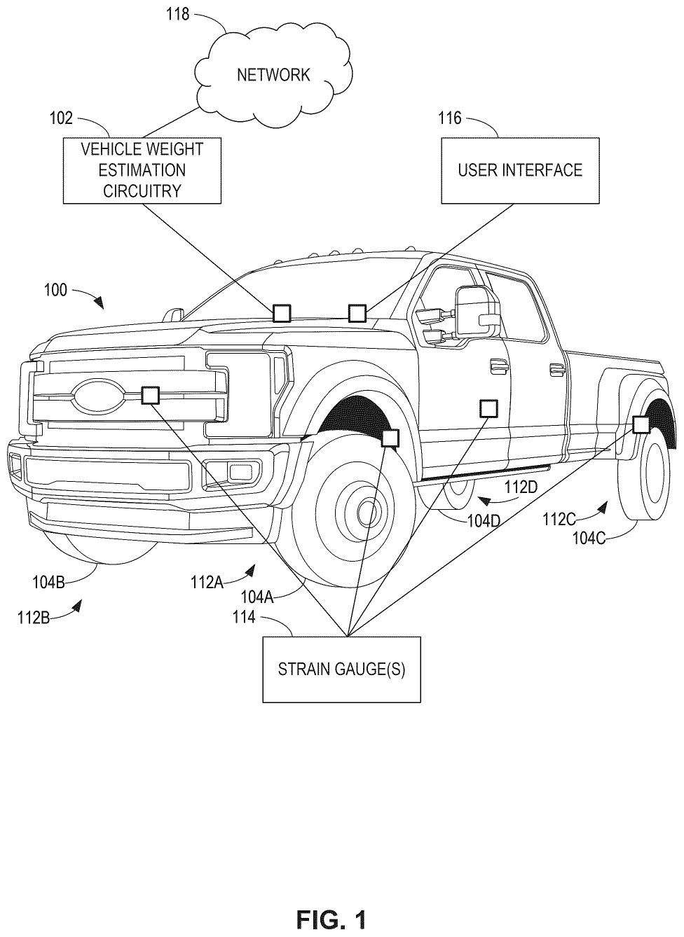

FIG. 1 illustrates an example vehicle 100 implementing example vehicle weight estimation circuitry 102 in accordance with teachings of this disclosure. In the illustrated example of FIG. 1, the vehicle 100 is a truck. In some examples, the vehicle 100 can be a different type of vehicle (e.g., a sedan, a van, a sport utility vehicle (SUV), etc.). In the example of FIG. 1, the vehicle 100 includes a first wheel (e.g., a left front (LF) wheel) 104A and a second wheel (e.g., a right front (RF) wheel) 104B, a third wheel (e.g., a left rear (LR) wheel) 104C, and a fourth wheel (e.g., a right rear (RR) wheel) 104D (collectively referred to herein as wheels 104). In this example, the first and second wheels (e.g., the front wheels) 104A, 104B are coupled to and/or associated with a front axle 110A of the vehicle 100, and the third and fourth wheels (e.g., the rear wheels) 104C, 104D are coupled to and/or associated with a rear axle 110B of the vehicle 100.

Additionally, the vehicle 100 of FIG. 1 includes example suspension systems 112A, 112B, 112C, 112D (collectively referred to herein as suspension systems 112) operatively coupled to respective ones of the wheels 104. For example, the vehicle 100 includes a first suspension system 112A operatively coupled to the first wheel 104A, a second suspension system 112B operatively coupled to the second wheel 104B, a third suspension system 112C operatively coupled to the third wheel 104C, and a fourth suspension system 112D operatively coupled to the fourth wheel 104D. In this example, the suspension systems 112 are MacPherson strut suspension systems. In some examples, one or more different types of suspension systems can be used for one(s) of the suspension systems 112 (e.g., passive double wishbone (SLA) suspensions, trailing-arm suspensions, active and/or semi-active suspension systems, etc.). In some examples, the suspension systems 112 can include shock absorbers and/or struts that may be mounted to the vehicle 100 (e.g., to a body and/or frame of the vehicle 100) via one or more example shock towers.

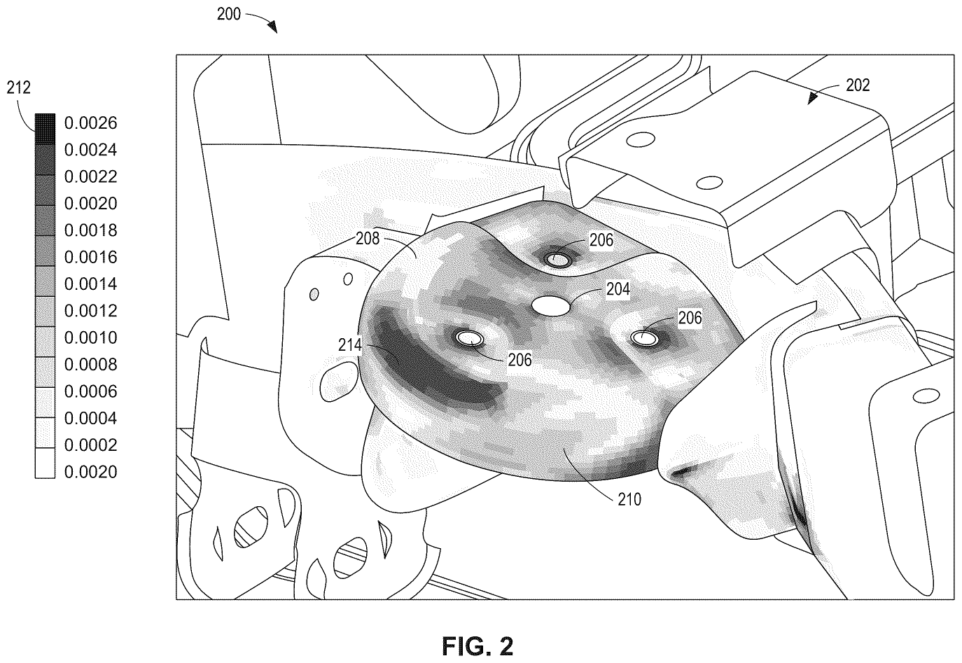

FIG. 2 is a perspective view of an example shock tower 200 that may be implemented on the example vehicle 100 of FIG. 1. For example, the shock tower 200 may be associated with one of the suspension systems 112 of FIG. 1. In the illustrated example of FIG. 2, the shock tower 200 is coupled to an example frame 202 of the vehicle 100 and includes one or more example openings (e.g., a shock absorber opening 204 and fastener openings 206) for receiving and/or mounting a shock absorber. In this example, the shock absorber opening 204 is positioned at or near a center of a top surface 208 of the shock tower 200, and the fastener openings 206 are positioned in the top surface 208 and spaced about a circumference of the shock absorber opening 204. In this example, the shock tower 200 includes three of the fastener openings 206. In some examples, the number of, the position(s) of, and/or the spacing between the openings 204, 206 may be different.

In some examples, an increase in load on the vehicle 100 (e.g., as a result of an increase in the number passengers and/or an increase in cargo positioned in and/or on the vehicle 100) may result in deformation of and/or strain on one or more surfaces (e.g., the top surface 208 and/or a side surface 210) of the shock tower 200. In the illustrated example of FIG. 2, an example indicator 212 represents example strain values measured and/or determined for the shock tower 200 as a result of such loading. For example, the indicator 212 relates example patterns, colors, and/or shading at respective locations of the shock tower 200 to corresponding strain values measured and/or determined for the respective locations. In this example, the strain values are increased (e.g., relative to other locations of the shock tower 200) proximate a distal end 214 of the shock tower 200 (e.g., a location of the top surface 208 that is furthest from the vehicle frame 202). Further, in this example, the strain values are increased (e.g., relative to other locations of the shock tower 200) at one or more locations of the side surface 210 and/or on the top surface 208 between adjacent ones of the fastener openings 206. In some examples, the strain values corresponding to one or more locations of the shock tower 200 may be different (e.g., as a result of a change in the load on the vehicle 100 and/or a change in characteristics (e.g., geometry, material composition, etc.) of the shock tower 200).

In some examples, the strain values (e.g., as represented by the indicator 212 of FIG. 2) may be determined and/or estimated based on results of finite element analysis of a computer model (e.g., a computer-aided design (CAD) model) corresponding to the shock tower 200. In some examples, the strain values may be determined based on strain measurements from one or more strain sensors (e.g., strain gauges) positioned on the shock tower 200. In some examples, the strain values may be used to inform and/or assist in selection of mounting positions for the strain sensor(s). For example, the strain sensor(s) may be positioned proximate location(s) of the shock tower 200 at which the strain value(s) are expected to be elevated and/or increased (e.g., relative to other locations of the shock tower 200).

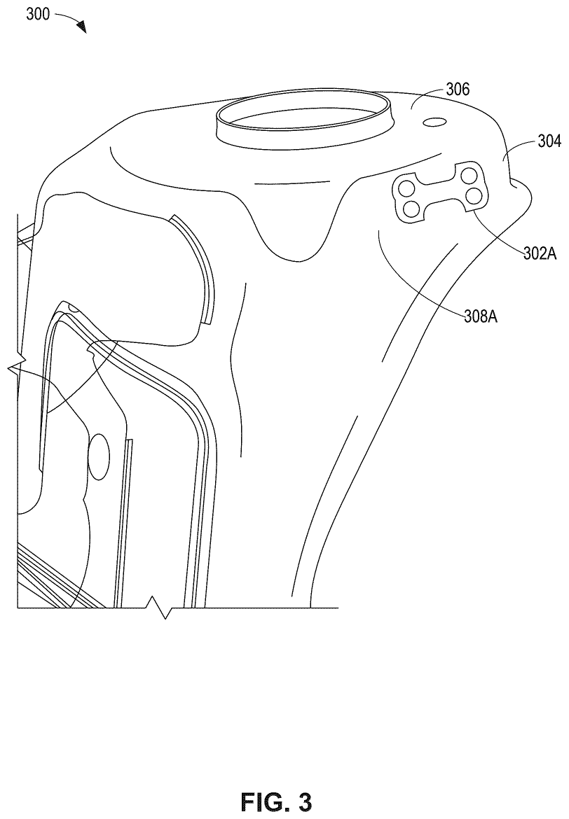

Returning to FIG. 1, the vehicle 100 further includes one or more example strain gauges (e.g., strain sensors) 114 operatively coupled to and/or mounted on respective shock towers (e.g., the shock tower 200 of FIG. 2) associated with respective one(s) of the suspension systems 112. In this example, four of the strain gauges 114 are mounted to respective different shock towers proximate respective corners and/or wheels 104 of the vehicle 100. While one of the strain gauges 114 is mounted per shock tower in this example, a different number of the strain gauges 114 may be used instead (e.g., two or more of the strain gauges 114 may be mounted on a single shock tower in some examples). In some examples, locations (e.g., mounting locations) for the respective strain gauges 114 are selected based on the expected strain values (e.g., as shown in FIG. 2) at the respective locations. In some examples, the locations are selected to provide a relatively flat surface for the strain gauges 114. Selection of mounting locations for the strain gauges 114 and candidate mounting locations are described further below in connection with FIGS. 3-6.

In the illustrated example of FIG. 1, the vehicle weight estimation circuitry 102 is communicatively coupled to the strain gauges 114 to access, retrieve, and/or otherwise obtain example strain measurements (e.g., strain measurement data) from the strain gauges 114. In some examples, the strain measurements represent strain on a surface of the respective shock towers. In the example of FIG. 1, based on the strain measurements, the vehicle weight estimation circuitry 102 can determine at least one of a GVW of the vehicle 100, a magnitude and/or location corresponding to a load on the vehicle 100, and/or corner weights associated with respective wheels 104 (e.g., proximate respective corners) of the vehicle 100. The vehicle weight estimation circuitry 102 is further communicatively coupled to an example user interface (e.g., a Human-Machine Interface (HMI)) 116 of the vehicle 100. In some examples, the vehicle weight estimation circuitry 102 can cause presentation of the measured and/or determined values (e.g., the strain measurements, the GVW, the magnitude and/or location of the load, the corner weights, etc.) via the user interface 116. Further, in some examples, the vehicle weight estimation circuitry 102 is communicatively coupled to one or more additional devices via, for example, an example network 118. In such examples, the vehicle weight estimation circuitry 102 can provide, via the network 118, the measured and/or determined values to the additional device(s) for storage and/or presentation thereon.

FIGS. 3-6 illustrate example mounting locations (e.g., candidate mounting locations) of an example shock tower 300 at which one(s) of the strain gauges 114 of FIG. 1 may be implemented. In the examples of FIGS. 3-6, the shock tower 300 is associated with the first suspension system 112A and/or with the first wheel (e.g., the front left wheel) 104A of the vehicle 100 of FIG. 1. In some examples, the shock tower 300 may be associated with a different one of the suspension systems 112 and/or the wheels 104 of FIG. 1.

Turning to FIG. 3, a first example mounting location (e.g., a first candidate location) 302A for the strain gauge 114 is shown. In the illustrated example of FIG. 3, the first mounting location 302A is on an example side surface 304 of the shock tower 300, where the side surface 304 extends downward (e.g., substantially perpendicularly downward) from a top surface 306 of the shock tower 300. In particular, the first mounting location 302A is on a forward-facing portion 308A of the side surface 304, where the forward-facing portion 308A faces forward with respect to the vehicle 100 of FIG. 1.

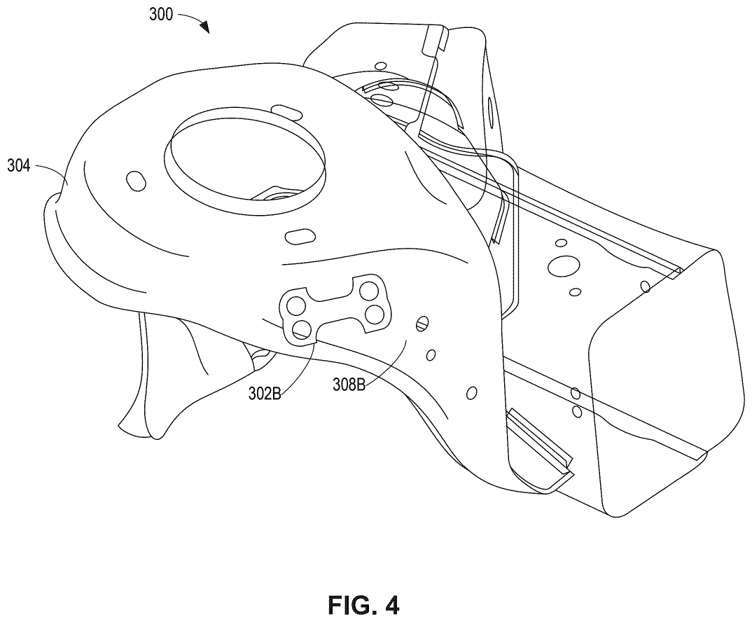

Alternatively, FIG. 4 illustrates a second example mounting location (e.g., a second candidate location) 302B on the shock tower 300 of FIG. 3. In the illustrated example of FIG. 4, the second mounting location 302B is on a rearward-facing portion 308B of the side surface 304, where the rearward-facing portion 308B faces rearward with respect to the vehicle 100 of FIG. 1.

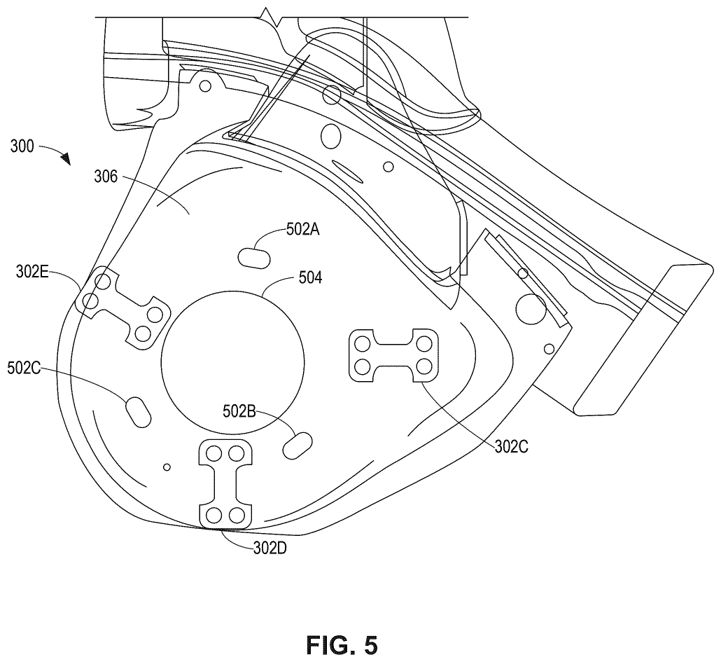

FIG. 5 is a top view of the shock tower 300 of FIGS. 3 and/or 4 with additional example mounting locations shown. In particular, FIG. 5 illustrates third, fourth, and fifth example mounting locations (e.g., third, fourth, and fifth candidate locations) 302C, 302D, 302E on the top surface 306 of the shock tower 300. In the illustrated example of FIG. 5, the third mounting location 302C is between first and second fastener openings 502A, 502B in the top surface 306, the fourth mounting location 302D is between the second fastener opening 502B and a third fastener opening 502C in the top surface 306, and the fifth mounting location 302E is between the first and third fastener openings 502A, 502C, where the fastener openings 502A, 502B, 502C are spaced around a circumference of a shock absorber opening 504 in the top surface 308.

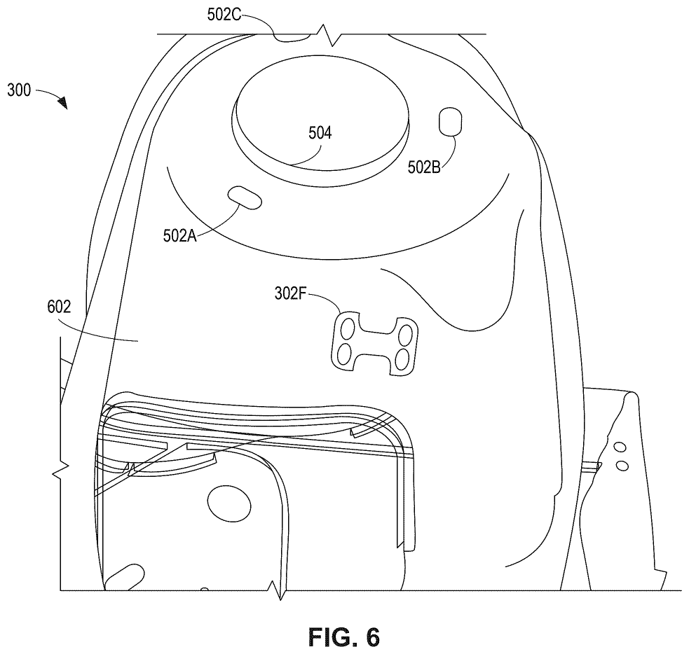

FIG. 6 illustrates a sixth example mounting location (e.g., a sixth candidate location) 302F for the strain gauge 114. In the illustrated example of FIG. 6, the sixth mounting location 302F is on an example inner surface 602 of the shock tower 300, where the inner surface 602 is to face a shock absorber when the shock absorber is mounted to the shock tower 300 (e.g., via the shock absorber opening 504 and/or the fastener openings 502A, 502B, 502C). In some examples, the sixth mounting location 302F corresponds to a substantially flat portion of the inner surface 602.

In some examples, the strain gauge 114 can be operatively coupled and/or mounted to any one of the mounting locations 302 (e.g., the first mounting location 302A, the second mounting location 302B, the third mounting location 302C, the fourth mounting location 302D, the fifth mounting location 302E, and/or the sixth mounting location 302F) of FIGS. 3-6. For example, the strain gauge 114 can be coupled to one of the mounting locations 302 that provides a more consistent signal and/or that results in strain measurements having reduced noise (e.g., compared to other one(s) of the mounting locations 302). In some examples, the third mounting location 302C provides more consistent strain measurement signals (e.g., compared to other one(s) of the mounting locations 302) and, as a result, the third mounting location 302C is selected for the strain gauge 114. In some examples, a different one of the mounting locations 302 may be selected instead. Further, in some examples, the third mounting location 302C is used for multiple (e.g., all) shock towers of the vehicle 100. For example, the strain gauges 114 of FIG. 1 can be coupled to respective ones of the shock towers (e.g., corresponding to respective wheels 104 and/or corners of the vehicle 100) at the third mounting location 302C. In some examples, different mounting locations 302 can be selected for different ones of the shock towers.

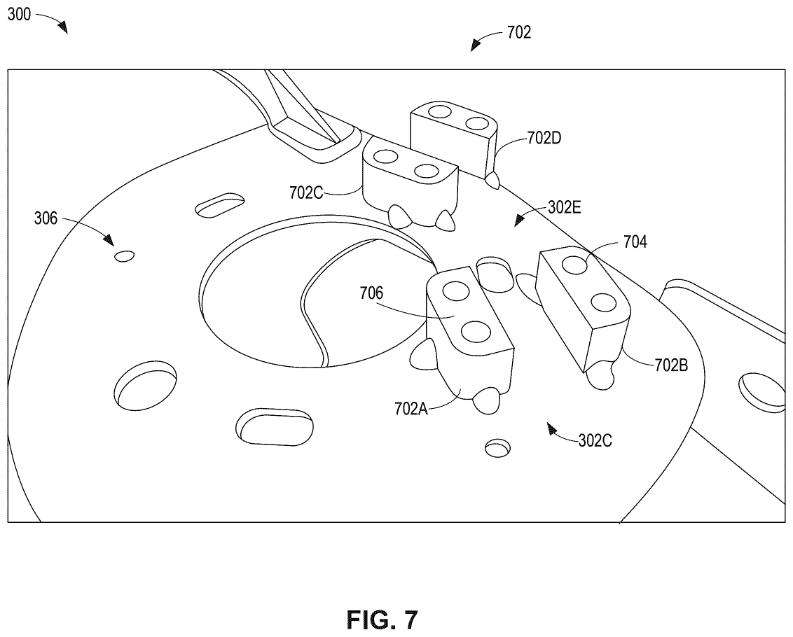

FIG. 7 illustrates the example shock tower 300 of FIGS. 3-6 including example mounting blocks 702. In the illustrated example of FIG. 7, the shock tower 300 includes first and second example mounting blocks 702A, 702B coupled to the top surface 306 of the shock tower 300 at the third mounting location 302C, and third and fourth example mounting blocks 702C, 702D coupled to the top surface 306 of the shock tower 300 at the fifth mounting location 302E. In some examples, location(s) at which the mounting blocks 702A, 702B are mounted may be different. For example, one(s) of the mounting blocks 702A, 702B may be mounted and/or coupled to different one(s) of the mounting locations 302 described in connection with FIGS. 3-6, and/or can be mounted to location(s) different from the mounting locations 302. In this example, the mounting blocks 702 are welded to the top surface 306. In some examples, the mounting blocks 702 may be integrally formed in the shock tower 300 (e.g., during a casting or stamping process for the shock tower 300), and/or can be removably coupled to the top surface 306 (e.g., via one or more fasteners) in some examples. In some examples, the mounting blocks 702 may be coupled to the shock tower 300 via brazing, soldering, riveting, and/or adhesive bonding. In the illustrated example of FIG. 7, the mounting blocks 702 include example threaded openings 704 for receiving a screw or other fastener to fasten a respective one of the strain gauges 114 of FIG. 1 to the shock tower 300. The threaded openings 704 are positioned in mounting surfaces 706 of the respective mounting blocks 702, where the mounting surfaces 706 are to contact the strain gauge(s) 114 when the strain gauge(s) 114 are fastened to the mounting blocks 702.

In some examples, corresponding pairs of the mounting blocks 702 (e.g., the first and second mounting blocks 702A, 702B, the third and fourth mounting blocks 702C, 702D, etc.) are sized, shaped, and/or positioned to provide a substantially flat surface for mounting the respective strain gauge 114. For example, when a portion of the top surface 306 (e.g., corresponding to the third mounting location 302C and/or the fifth mounting location 302E) is curved, the corresponding pair(s) of mounting blocks 702 are sized, shaped, and/or positioned such that the mounting surfaces 706 of the mounting blocks 702 provide a substantially flat (e.g., not curved) surface. In some such examples, to provide the substantially flat surface, a first one of the mounting blocks 702 (e.g., the first mounting block 702A, the third mounting block 702C) can have an increased height relative to a corresponding second one of the mounting blocks 702 (e.g., the second mounting block 702B, the fourth mounting block 702D), and/or the mounting surface 706 of the first one of the mounting blocks 702 can be angled relative to the mounting surface 706 of the second one of the mounting blocks 702.

In some examples, the mounting blocks 702 can magnify, exaggerate, and/or enhance strain measurements obtained by the strain gauges 114. For example, the strain measurements obtained by the strain gauges 114 may be increased when the strain gauges 114 are coupled to the mounting blocks 702 compared to when the strain gauges 114 are coupled directly to a surface (e.g., the top surface 306) of the shock tower 300 (e.g., without the mounting blocks 702). Stated differently, a first strain measured by the strain gauges 114 when mounted on the mounting surface 706 of the mounting blocks 702 can be greater than a second strain measured by the strain gauges 114 when mounted on a surface (e.g., a portion of the top surface 306) of the shock tower 300. As a result, strain can be more easily detected when the strain gauges 114 are coupled to the shock tower 300 via the mounting blocks 702 (e.g., compared to when the mounting blocks 702 are not used).

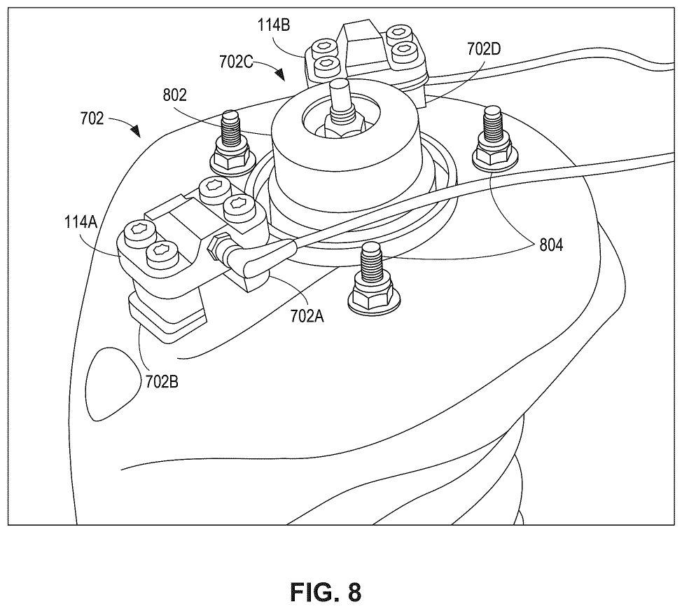

FIG. 8 illustrates the example shock tower 300 including the mounting blocks 702 of FIG. 7, with ones of the strain gauges 114 (e.g., a first strain gauge 114A and a second strain gauge 114B) coupled to respective ones of the mounting blocks 702. For example, the first strain gauge 114A is coupled to the first and second mounting blocks 702A, 702B, and the second strain gauge 114B is coupled to the third and fourth mounting blocks 702C, 702D. Further, in the illustrated example of FIG. 8, an example shock absorber (e.g., a shock absorber assembly) 802 is mounted to the shock tower 300 via fasteners 804. In some examples, by mounting the strain gauges 114A, 114B to substantially flat surfaces of the respective mounting blocks 702, the strain gauges 114A, 114B can provide more consistent signals and/or less noisy measurements (e.g., compared to when the strain gauges 114A, 114B are mounted directly to curved surfaces of the shock tower 300). In this example, two of the mounting blocks 702 are used to mount one of the strain gauges 114 to the shock tower 300. In some examples, a different number of the mounting blocks 702 may be used for mounting a respective one of the strain gauges 114. For example, a corresponding pair of the mounting blocks 702 (e.g., the first and second mounting blocks 702A, 702B, the third and fourth mounting blocks 702C, 702D) can be formed as a single part on the shock tower 300 in some examples.

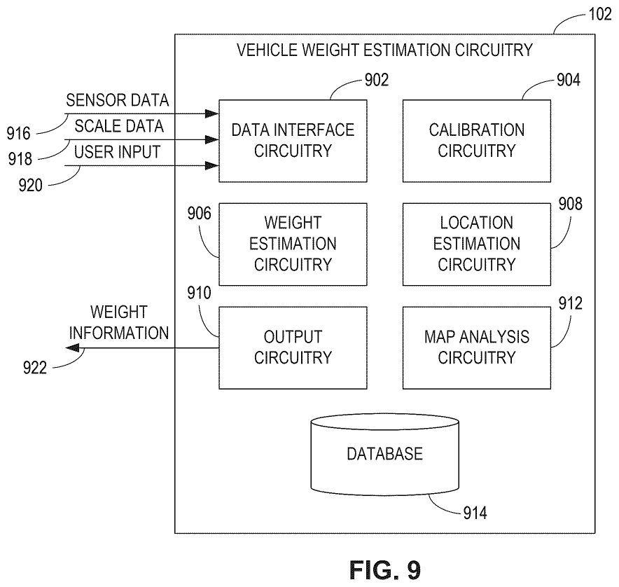

FIG. 9 is a block diagram of an example implementation of the example vehicle weight estimation circuitry 102 of FIG. 1. The vehicle weight estimation circuitry 102 of FIG. 9 may be instantiated (e.g., creating an instance of, bring into being for any length of time, materialize, implement, etc.) by programmable circuitry such as a Central Processor Unit (CPU) executing first instructions. Additionally or alternatively, the vehicle weight estimation circuitry 102 of FIG. 9 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 9 may, thus, be instantiated at the same or different times. Some or all of the circuitry of FIG. 9 may be instantiated, for example, in one or more threads executing concurrently on hardware and/or in series on hardware. Moreover, in some examples, some or all of the circuitry of FIG. 9 may be implemented by microprocessor circuitry executing instructions and/or FPGA circuitry performing operations to implement one or more virtual machines and/or containers.

In the illustrated example of FIG. 9, the vehicle weight estimation circuitry 102 includes example data interface circuitry 902, example calibration circuitry 904, example weight estimation circuitry 906, example location estimation circuitry 908, example output circuitry 910, example map analysis circuitry 912, and an example database 914.

The example database 914 of FIG. 9 stores data utilized and/or determined by the vehicle weight estimation circuitry 102. The example database 914 of FIG. 9 is implemented by any memory, storage device and/or storage disc for storing data such as, for example, flash memory, magnetic media, optical media, solid state memory, hard drive(s), thumb drive(s), etc. Furthermore, the data stored in the database 914 may be in any data format such as, for example, binary data, comma delimited data, tab delimited data, structured query language (SQL) structures, etc. While, in the illustrated example, the database 914 is illustrated as a single device, the example database 914 and/or any other data storage devices described herein may be implemented by any number and/or types of memories and/or software.

The data interface circuitry 902 of FIG. 9 access, retrieves, and/or otherwise obtains example input data to be utilized by the vehicle weight estimation circuitry 102 for estimating weight(s) (e.g., GVW, corner weight(s), load weight(s), etc.) associated with the vehicle 100 of FIG. 1. For example, the data interface circuitry 902 can obtain, from the strain gauges 114 of FIG. 1, example sensor data 916 including strain measurements associated with respective shock towers (e.g., the shock tower 300 of FIGS. 3-8) of the vehicle 100. In some examples, the strain measurements represent strain on a surface of the shock tower to which a respective one of the strain gauges 114 is mounted.

Further, in the example of FIG. 9, the data interface circuitry 902 obtains example scale data 918 associated with the vehicle 100, and/or example user input (e.g., user input data) 920 provided via, for example, the user interface 116 of FIG. 1. In some examples, the vehicle 100 can be driven and/or placed onto one or more scales (e.g., at a weigh station, at a manufacturing facility, etc.) to obtain the scale data 918. In some such examples, the data interface circuitry 902 is communicatively coupled to the scale(s) to obtain weight measurement(s) therefrom. Additionally or alternatively, an operator can read the weight measurement(s) output by the scale(s), then provide the weight measurement(s) to the data interface circuitry 902 (e.g., via the user input 920).

In some examples, the scale data 918 can represent measured weight(s) of the vehicle 100 corresponding to respective different times and/or loading conditions. For example, the scale data 918 can include a measured curb weight (e.g., a vehicle curb weight) of the vehicle 100. In some examples, the measured curb weight corresponds to an output of the scale when the vehicle 100 is unloaded (e.g., when there are no passengers and no cargo on the vehicle 100). In some examples, the scale data 918 can include one or more corner curb weights (e.g., measured corner curb weights) corresponding to respective wheels 104 of the vehicle 100. In some examples, to obtain the corner curb weights, the unloaded vehicle 100 is driven and/or placed onto multiple scales (e.g., such that the wheels 104 are positioned on respective ones of the scales). In such examples, the output (e.g., the measured weight) from one of the scales indicates the corner curb weight associated with the wheel 104 positioned on the scale. In some examples, the curb weight and/or the corner curb weight(s) are manufacturer-provided values and, thus, may be provided to the data interface circuitry 902 (e.g., via the user input 920) without the use of one or more scales.

In some examples, the corner curb weights and the corresponding strain measurements are stored as example data samples (e.g., calibration samples) in the example database 914. For example, when one of the wheels 104 is positioned on a scale, the data interface circuitry 902 obtains the corner curb weight output from the scale, and further obtains the strain measurement output from one of the strain gauges 114 associated with the one of the wheels 104. In such examples, the data interface circuitry 902 causes the database 914 to store the corner curb weight and the corresponding strain measurement as an example data sample corresponding to the one of the wheels 104.

In some examples, the data interface circuitry 902 obtains additional data samples for respective ones of the wheels 104 based on results from an example calibration process. In such a calibration process, a load (e.g., a calibration load) is positioned on the vehicle 100 at an example calibration location (e.g., a starting location, an initial calibration location) along a two-dimensional (2-D) plane (e.g., a horizontal plane, a transverse plane) of the vehicle 100. In some examples, the calibration location corresponds to an expected center of mass of the vehicle 100 (e.g., the expected center of mass when the vehicle 100 is loaded with passengers and/or cargo). In some examples, the calibration location is approximately equidistant (e.g., along the 2-D plane) from respective ones of the wheels 104. In some examples, a different calibration location may be used instead.

In some examples, the data interface circuitry 902 detects and/or determines that the load is positioned at the calibration location based on a change in the scale data 918 (e.g., an increase in the measured corner weight(s) output by one or more scales) and/or based on the user input 920.

When the load is detected, the data interface circuitry 902 obtains the measured corner weights (e.g., via the scale data 918 and/or the user input 920) and the strain measurements (e.g., via the sensor data 916) associated with the respective ones of the wheels 104. In such examples, the data interface circuitry 902 causes the database 914 to store the measured corner weights in association with the corresponding strain measurements as data samples associated with the respective wheels 104. Further, during the calibration process, a weight (e.g., a magnitude) of the load may be adjusted (e.g., increased and/or decreased), and the data interface circuitry 902 can cause storage of additional data samples (e.g., additional measured corner weights and corresponding strain measurements) corresponding to the adjusted load weight. In some examples, the data interface circuitry 902 determines that the calibration process is complete when a number (e.g., a quantity) of the data samples satisfies (e.g., is greater than or equal to) an example threshold (e.g., at least 2 data samples, 10 or more data samples, etc.).

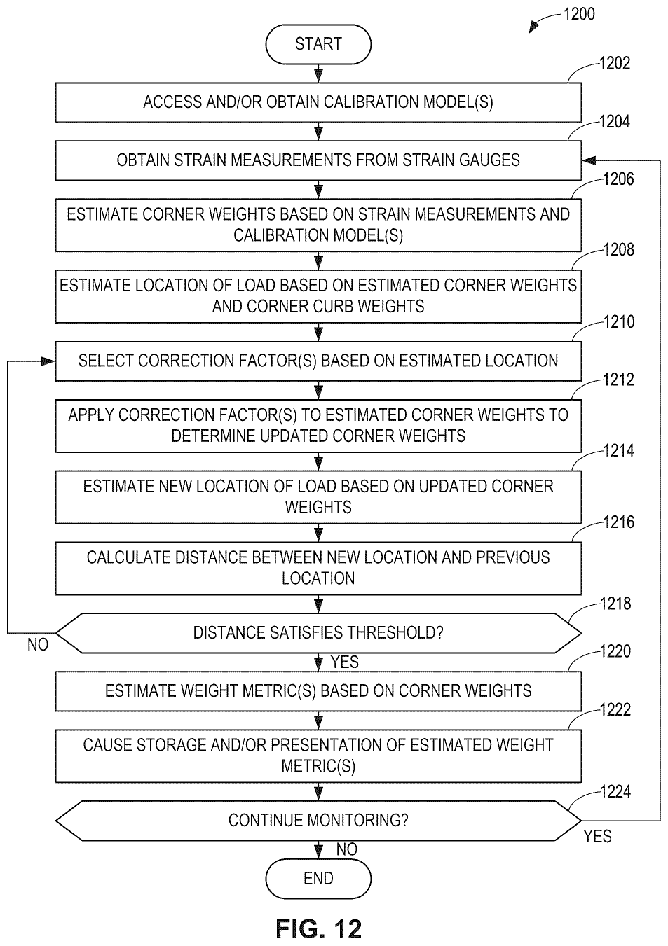

In the example of FIG. 9, the data interface circuitry 902 can further obtain data samples corresponding to respective different locations of the load on the vehicle 100. For example, in addition to or instead of the weight of the load being adjusted, a location of the load (e.g., with respect to the 2-D plane of the vehicle 100) may be adjusted, and the resulting corner weights and/or strain measurements may be recorded as data samples. For example, the load may be positioned forward or rearward relative to the initial calibration location, and/or may be positioned closer to the right side or the left side of the vehicle 100 (e.g., relative to the initial calibration location). In some examples, the data interface circuitry 902 determines the location of the load (e.g., with respect to the initial calibration location) along the 2-D plane of the vehicle 100 based on the user input 920. In some such examples, the load location is stored (e.g., in the database 914) in association with the corresponding data samples for respective ones of the wheels 104. In some examples, the data interface circuitry 902 is instantiated by programmable circuitry executing data interface circuitry instructions and/or configured to perform operations such as those represented by the flowchart(s) of FIGS. 12 and/or 13.

The calibration circuitry 904 of FIG. 9 generates and/or updates one or more example calibration models (e.g., calibration curves) for use in estimating vehicle weight(s) (e.g., corner weight(s), load weight(s), GVW(s), etc.) of the vehicle 100. For example, the calibration circuitry 904 can generate the calibration models to output estimated corner weights based on the strain measurements associated with the respective ones of the wheels 104 (e.g., the strain measurements from the respective strain gauges 114 mounted to shock towers associated with the wheels 104).

In the illustrated example of FIG. 9, to generate the calibration model for a corresponding one of the wheels 104, the calibration circuitry 904 accesses (e.g., from the database 914) a portion of the data samples obtained (e.g., by the data interface circuitry 902) for the corresponding wheel 104. For example, the portion of the data samples includes the strain measurements and the corresponding corner weights measured at the wheel 104 when the load is positioned at the calibration location. In some examples, the calibration circuitry 904 determines a correlation (e.g., a linear relationship) between the strain measurements and the corresponding corner weights.

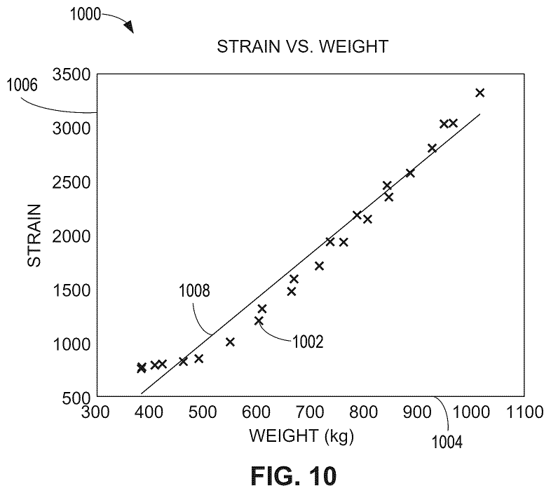

For example, FIG. 10 illustrates an example plot 1000 representative of example data samples 1002 corresponding to one of the wheels 104 of FIG. 1. In the illustrated example of FIG. 10, the plot 1000 includes a first example axis (e.g., a horizontal axis) 1004 representing example corner weights (e.g., in kilograms (kg)) measured at the wheel 104, and a second example axis (e.g., a vertical axis) 1006 representing the strain on a shock tower associated with the wheel 104. In this example, the data samples 1002 represent the strain and the corner weights resulting from respective different load weights applied to the vehicle 100 (e.g., at the calibration location).

In the illustrated example of FIG. 10, the calibration circuitry 904 generates and/or obtains an example calibration model 1008 based on the data samples 1002. For example, the calibration circuitry 904 can perform linear regression based on the data samples 1002 to obtain the calibration model 1008. In some examples, the calibration model 1008 can be represented using a gain value and an offset value, where the gain value is based on a slope of the calibration model 1008 and the offset value is based on an intercept (e.g., a y-intercept) of the calibration model 1008 with respect to the second axis 1006. In some examples, the offset value represents strain on a shock tower associated with the respective wheel 104 when no load is applied to the vehicle 100. In some examples, the calibration circuitry 904 provides the calibration model 1008 to the database 914 for storage therein.

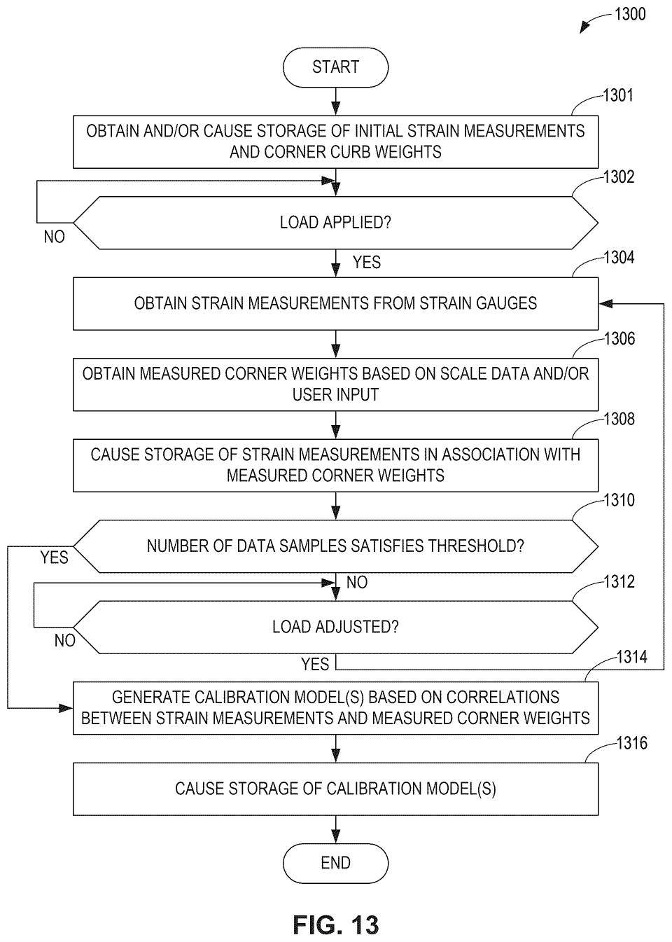

In some examples, the calibration circuitry 904 similarly generates one or more additional calibration models for respective remaining one(s) of the wheels 104 of FIG. 1, and causes storage of the calibration models in the database 914 of FIG. 9. While four of the calibration models are generated in this example (e.g., one calibration model per wheel 104), a different number of the calibration models may be used instead. For example, a first calibration model can be generated for the front wheels (e.g., the first and second wheels 104A, 104B) of the vehicle 100, and a second calibration model can be generated for the rear wheels (e.g., the third and fourth wheels 104C, 104D) of the vehicle 100. In some examples, the model(s) are calibrated for a respective vehicle (e.g., the vehicle 100) and/or vehicle type, and the model(s) are re-calibrated (e.g., new calibration model(s) are generated) for respective different vehicles and/or vehicle types. In some examples, the calibration circuitry 904 is instantiated by programmable circuitry executing calibration circuitry instructions and/or configured to perform operations such as those represented by the flowchart(s) of FIG. 13.

Returning to FIG. 9, the weight estimation circuitry 906 of FIG. 9 utilizes the calibration model(s) to determine and/or estimate example weight(s) of the vehicle 100. For example, when measured weight(s) for the vehicle 100 are not available (e.g., the vehicle 100 is in operation and/or is no longer positioned on one or more scales), the weight estimation circuitry 906 can utilize the sensor data 916 from the strain gauges 114 of FIG. 1 and the calibration model(s) to estimate the corner weight(s), the GVW, and/or the load weight on the vehicle 100. In such examples, the weight estimation circuitry 906 can estimate the vehicle weight(s) without the use of scales and/or designated weight sensor(s) on the vehicle 100 and, as a result, may reduce weight associated with the vehicle 100.

In the illustrated example of FIG. 9, the weight estimation circuitry 906 obtains, from the sensor data 916, the strain measurements associated with respective shock towers of the wheels 104. Further, the weight estimation circuitry 906 obtains, from the database 914, the calibration models for respective ones of the wheels 104. Using the calibration models, the weight estimation circuitry 906 estimates corner weights at respective ones of the wheels 104 based on the respective strain measurements. In some examples, the weight estimation circuitry 906 further estimates a GVW of the vehicle 100 based on the estimated corner weights. For example, the weight estimation circuitry 906 estimates the GVW based on an aggregate (e.g., a sum) of the corner weights. In some examples, the weight estimation circuitry 906 determines the load weight (e.g., the weight of the load on the vehicle 100) based on a difference between the GVW and the curb weight of the vehicle 100. Additionally or alternatively, the weight estimation circuitry 906 can determine one or more corner load weights (e.g., a weight of the load at respective wheels 104 of the vehicle 100) based on differences between the estimated corner weights and the corresponding corner curb weights for the respective wheels 104. In some examples, the weight estimation circuitry 906 provides one or more estimated values (e.g., the estimated corner weight(s), the estimated GVW, the estimated load weight, the estimated corner load weight(s), etc.) to the database 914 for storage therein. In some examples, the weight estimation circuitry 906 is instantiated by programmable circuitry executing weight estimation circuitry instructions and/or configured to perform operations such as those represented by the flowchart(s) of FIG. 12.

The location estimation circuitry 908 of FIG. 9 estimates an example location (e.g., a center of mass location) of the load on the vehicle 100. For example, based on the corner load weights (e.g., the corner weights associated with the load on the vehicle 100), the location estimation circuitry 908 can estimate the location of a center of mass of the load along a 2-D plane (e.g., a horizontal plane, a ground plane) of the vehicle 100. In some examples, the location estimation circuitry 908 estimates the location based on ratio(s) between the corner load weights. For example, when the corner load weights are approximately the same across the respective wheels 104 (e.g., the load is evenly distributed across the wheels 104), the location estimation circuitry 908 may estimate that the center of mass of the load is approximately equidistant between the wheels 104 (e.g., the center of mass is approximately halfway between the front wheels 104A, 104B and the rear wheels 104C, 104D along a longitudinal axis of the vehicle 100, and the center of mass is approximately halfway between the left wheels 104A, 104C and the right wheels 104B, 104D along a lateral axis of the vehicle 100).

In another example, the corner load weights may vary between the wheels 104. For example, a first corner load weight associated with the first wheel 104A may be approximately 40 kilograms (kg), a second corner load weight associated with the second wheel 104B may be approximately 20 kg, a third corner load weight associated with the third wheel 104C may be approximately 30 kg, and a fourth corner load weight associated with the fourth wheel 104D may be approximately 10 kg (e.g., resulting in a total load on the vehicle of approximately 100 kg). In such an example, the location estimation circuitry 908 determines that the center of mass of the load is biased 60/40 front to rear (e.g., 60 percent (%) of the load is on the front wheels 104A, 104B, and 40% of the load is on the rear wheels 104C, 104D), and the center of mass is further biased 70/30 left to right (e.g., 70% of the load is on the left wheels 104A, 104C, and 30% of the load is on the right wheels 104B, 104D).

In some examples, the location estimation circuitry 908 estimates, based on the ratios between the corner load weights, a longitudinal position and a lateral position of the center of mass (e.g., with respect to an origin at the first wheel 104A). For example, the longitudinal position is measured along a longitudinal axis extending between the front and rear wheels 104 (e.g., from the first wheel 104A to the third wheel 104C). Further, the lateral position is measured along a lateral axis extending between the left and right wheels 104 (e.g., from the first wheel 104A to the second wheel 104B). In the example above, the location estimation circuitry 908 estimates that the longitudinal position is approximately 40% of a first distance (e.g., a longitudinal distance) between the front wheels 104A, 104B and the rear wheels 104C, 104D, and further estimates that the lateral position is approximately 30% of a second distance (e.g., a lateral distance) between the left wheels 104A, 104C and the right wheels 104B, 104D. While the center of mass location in this example is described with respect to a coordinate system (e.g., the lateral and longitudinal axes) positioned at the first wheel 104, the location can be described with respect to a different coordinate system in some examples. In some examples, the location estimation circuitry 908 causes storage of the estimated location (e.g., the longitudinal and lateral positions) in the database 914. In some examples, the location estimation circuitry 908 is instantiated by programmable circuitry executing location estimation circuitry instructions and/or configured to perform operations such as those represented by the flowchart(s) of FIG. 12.

The map analysis circuitry 912 of FIG. 9 adjusts one or more estimated corner weights based on an example correction factor map (e.g., a gain map) generated and/or obtained by the map analysis circuitry 912. In some examples, the correction factor map includes example correction factors for adjusting gain values of the calibration models based on a location of the load. For example, when the load is shifted on the vehicle 100 relative to the initial calibration location (e.g., the initial location for which the calibration model(s) were generated), the shock towers may deform differently (e.g., at a different rate) compared to when the load is at the calibration location. As a result, corner weights estimated using the calibration model(s) may be inaccurate (e.g., may vary by more than a threshold amount from the measured (e.g., actual, true) corner weights). In such examples, the map analysis circuitry 912 can obtain, from the correction factor map, the correction factors corresponding to a current location of the load (e.g., the center of mass of the load). The map analysis circuitry 912 can apply the correction factors to (e.g., multiply the correction factors by) the corresponding gain values of the calibration models. In such examples, the adjusted calibration models (e.g., the calibration models having adjusted gain values) can be used to determine adjusted corner weight estimates, where the adjusted corner weight estimates may more accurately (e.g., compared to the previous corner weight estimates) represent the measured corner weights of the vehicle 100.

In some examples, the correction factor map is preloaded in the map analysis circuitry 912, and/or is generated by the map analysis circuitry 912 based on data samples collected by the data interface circuitry 902. For example, a location of the load (e.g., the calibration load) on the vehicle 100 can be shifted and/or adjusted to a second location (e.g., different from the initial calibration location). The vehicle 100 can then be loaded (or unloaded) by increasing (or decreasing) the load at the second location, and the data interface circuitry 902 can collect data samples (e.g., strain measurements and associated scale measurements) corresponding to the different loads applied at the second location. The map analysis circuitry 912 can determine a correlation (e.g., a linear relationship) between the strain measurements and the associated scale measurements, and determines adjusted gain values (e.g., for the respective strain gauges 114) based on the correlation. In some examples, the map analysis circuitry 912 stores, in the correction factor map, the adjusted gain values as example correction factors to be applied to the respective calibration model(s) when the load is positioned at the second location. For example, when the load is positioned at the second location, the calibration circuitry 904 utilizes the adjusted gain values in the calibration model(s) (e.g., instead of the initial gain values determined for the calibration model(s) at the calibration location). Additionally or alternatively, the map analysis circuitry 912 determines ratios between the adjusted gain values and the initial gain values, and stores, in the correction factor map, the ratios in association with the second location.

In some examples, the map analysis circuitry 912 repeats the above process for respective different locations of the load on the vehicle 100. As a result, the map analysis circuitry 912 determines correction factors corresponding to the respective different load locations at which the load may be positioned on the vehicle 100. In some examples, the map analysis circuitry 912 generates the correction factor map by storing (e.g., in the database 914) the correction factors (e.g., the adjusted gain values and/or the ratios) in association with the corresponding load locations. In some examples, the map analysis circuitry 912 can utilize the correction factor map to adjust the calibration model(s) to compensate for variations in strain measurements resulting from an imbalanced load distribution on the wheels 104. For example, the map analysis circuitry 912 can adjust the calibration model(s) by replacing initial gain values with the adjusted gain values from the correction factor map. In some examples, the map analysis circuitry 912 can adjust the calibration model(s) by multiplying the initial gain values by the ratios (e.g., to obtain the adjusted gain values).

In some examples, the location estimation circuitry 908 and the map analysis circuitry 912 can execute and/or perform a compensation algorithm to adjust, based on an estimated location of the load, one or more corner weights estimated by the weight estimation circuitry 906. For example, after the weight estimation circuitry 906 estimates the corner weights based on the sensor data 916, the location estimation circuitry 908 estimates a location (e.g., a center of mass location, a first load location) of the load based on the corner weights. Using the correction factor map, the map analysis circuitry 912 selects and/or identifies correction factors corresponding to the estimated load location. The map analysis circuitry 912 can apply the selected correction factors to the calibration model(s) to obtain adjusted calibration model(s) (e.g., calibration model(s) having adjusted gain values relative to the initial calibration model(s)), then determines updated corner weights for the respective wheels 104 based on the adjusted calibration model(s). In some examples, the location estimation circuitry 908 estimates a new and/or updated location (e.g., a second load location) of the load based on the updated corner weights, then calculates a distance (e.g., a 2-D distance along a horizontal plane of the vehicle 100) between the updated location and the previous estimated location.

In some examples, the distance between the updated and previous locations (e.g., the first and second load locations) represents an error associated with the updated location. In some examples, the location estimation circuitry 908 and/or the map analysis circuitry 912 repeat the process above until the distance between the previous and updated location estimates satisfies an example threshold (e.g., an error threshold). For example, when the distance does not satisfy (e.g., is greater than) the error threshold, the updated location is used as the first location (e.g., the previous location), and new correction factors and a new updated location is determined (e.g., by the map analysis circuitry 912 and/or the location estimation circuitry 908) based on the first location. Alternatively, when the distance satisfies (e.g., is less than or equal to) the error threshold, the location estimation circuitry 908 determines that convergence in the location estimate has been achieved and, thus, causes storage of the estimated location and the corresponding adjusted weights in the database 914. In some examples, the map analysis circuitry 912 is instantiated by programmable circuitry executing map analysis circuitry instructions and/or configured to perform operations such as those represented by the flowchart(s) of FIG. 12.

The output circuitry 910 of FIG. 9 generates and/or outputs example weight information 922 based on one or more weights obtained and/or estimated by the vehicle weight estimation circuitry 102. For example, the weight information 922 can include the estimated corner weight(s), the estimated GVW, the estimated load weight, and/or the estimated corner load weight(s) determined by the weight estimation circuitry 906. Further, in some examples, the weight information 922 can include the estimated load location (e.g., the estimated center of mass of the load) with respect to the 2-D plane of the vehicle 100 (e.g., as determined by the location estimation circuitry 908). In some examples, the output circuitry 910 is communicatively coupled to the user interface 116 of FIG. 1. In such examples, the output circuitry 910 can cause presentation (e.g., display) of the weight information 922 via the user interface 116 (e.g., to an operator of the vehicle 100). In some examples, the output circuitry 910 is communicatively coupled (e.g., via the network 118 of FIG. 1) to one or more additional (e.g., remote) devices. In such examples, the output circuitry 910 can provide the weight information 922 to the additional device(s) for presentation and/or storage thereon.

In some examples, the output circuitry 910 can generate an alert when the weight information 922 does not satisfy (e.g., exceeds) one or more weight ratings for the vehicle 100. For example, in response to the output circuitry 910 determining that the estimated GVW is greater than a gross vehicle weight rating (GVWR) of the vehicle 100, the output circuitry 910 can generate and/or output the alert (e.g., via the user interface 116) to inform an operator of the vehicle 100 and/or to instruct the operator to reduce a load on the vehicle 100. In some examples, the output circuitry 910 is instantiated by programmable circuitry executing output circuitry instructions and/or configured to perform operations such as those represented by the flowchart(s) of FIG. 12.

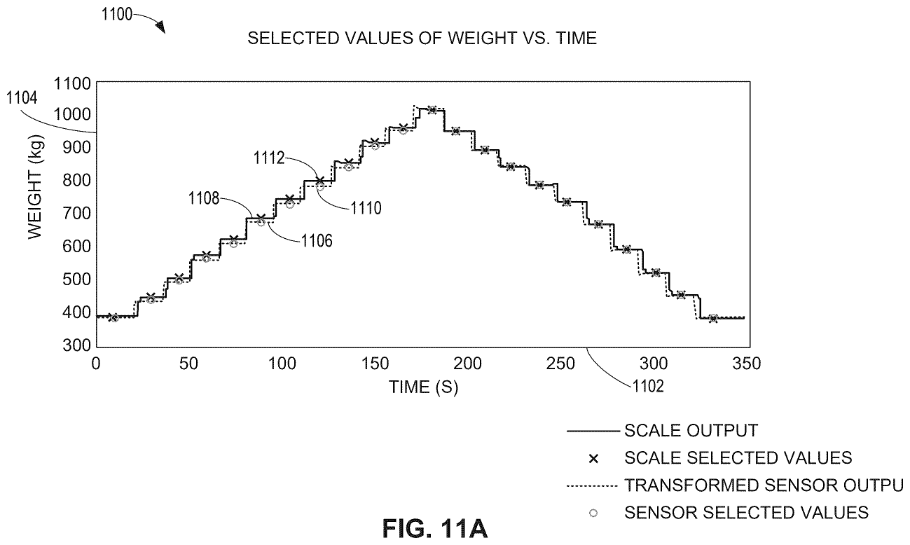

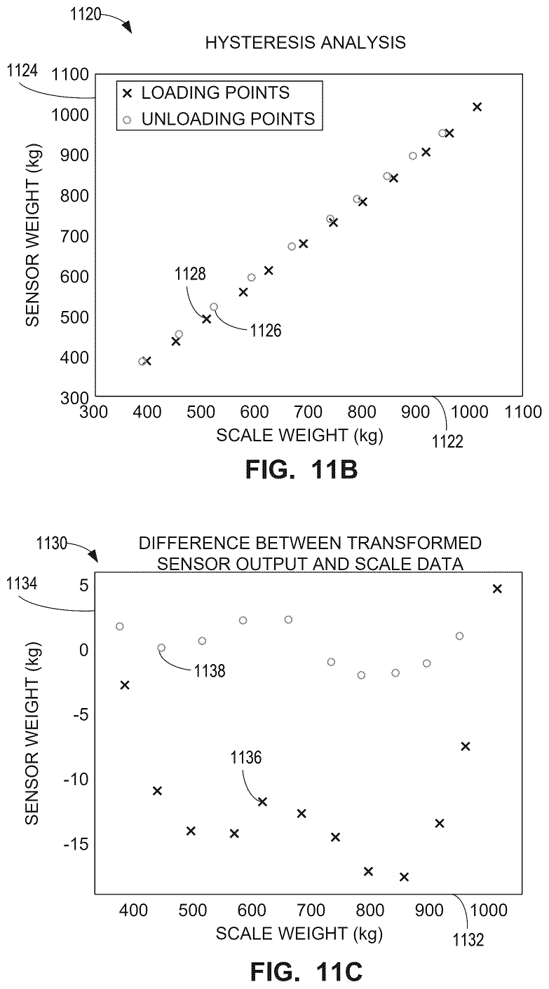

FIGS. 11A, 11B, and 11C illustrate example results of a comparison between estimated corner weights determined based on the sensor data 916 and measured corner weights determined based on the scale data 918. For example, FIG. 11A illustrates a first example graph 1100 representative of example estimated corner weights (e.g., based on the sensor data 916) and corresponding example measured corner weights (e.g., based on the scale data 918) obtained and/or determined for a respective one of the wheels 104 of FIG. 1. In some examples, the corner weights of FIG. 11A are determined during an example calibration procedure in which the vehicle is loaded (e.g., a weight of a load on the vehicle 100 is incrementally increased) for a first duration from a starting weight to a threshold weight, and the vehicle is unloaded (e.g., the weight of the load is incrementally reduced) for a second duration from the threshold weight to the starting weight.

In the illustrated example of FIG. 11A, the first graph 1100 includes a first example axis (e.g., a horizontal axis) 1102 representing durations (e.g., in seconds) relative to a start time, and a second example axis (e.g., a vertical axis) 1104 representing weight (e.g., in kilograms (kg)) at the wheel 104. Further, the first graph 1100 includes a first example line 1106 representative of the estimated corner weight at the respective durations, where the estimated corner weight is based on a transformed sensor output from one of the strain gauges 114 coupled to a shock tower of the wheel 104. In this example, the first graph 1100 includes a second example line 1108 representative of the measured corner weight at the respective durations. In the illustrated example of FIG. 11A, the first graph 1100 includes first example markers 1110 corresponding to selected values of the estimated corner weight, and further includes second example markers 1112 corresponding to selected values of the measured corner weight (e.g., the measured corner weights corresponding to the selected estimated corner weights). In this example, respective pairs of the selected values (e.g., the estimated corner weights and the corresponding measured corner weights) correspond to data samples obtained at corresponding durations along the first axis 1102.

FIG. 11B illustrates a second example graph 1120 representative of example hysteresis analysis results corresponding to the selected corner weight values (e.g., the estimated values and the corresponding measured values) of FIG. 11A. In the illustrated example of FIG. 11B, the second graph 1120 includes a third example axis 1122 representing the measured corner weight (e.g., a scale weight) in kilograms, and a fourth example axis 1124 representing the estimated corner weight (e.g., a sensor weight) in kilograms. In this example, the second graph 1120 includes third and fourth example markers 1126, 1128, where the markers 1126, 1128 of FIG. 11B represent respective different data samples of FIG. 11A (e.g., respective pairs of the first and second markers 1110, 1112 of FIG. 11A). For example, the markers 1126, 1128 of FIG. 11B represent the measured corner weights along the third axis 1122 and the corresponding estimated corner weights along the fourth axis 1124. In this example, the third markers 1126 represent first ones of the data samples obtained during loading (e.g., increasing a load) of the vehicle 100, and the fourth markers 1128 represent second ones of the data samples obtained during unloading (e.g., reducing the load) of the vehicle 100.

FIG. 11C illustrates a third example graph 1130 representative of error (e.g., differences) between the estimated corner weights and the corresponding measured corner weights of FIGS. 11A and/or 11B. For example, the third graph 1130 includes a fifth example axis 1132 representing an actual weight (e.g., the measured corner weight) in kilograms, and a sixth example axis 1134 representing absolute error (e.g., in kilograms) between the estimated corner weight and the corresponding measured corner weight. In the illustrated example of FIG. 11C, fifth example markers 1136 represent the error corresponding to first data samples obtained during loading of the vehicle 100 (e.g., corresponding to the third markers 1126 of FIG. 11B), and sixth example markers 1138 represent the error corresponding to second data samples obtained during unloading of the vehicle 100 (e.g., corresponding to the fourth markers 1128 of FIG. 11B). In the example of FIG. 11C, negative error values (e.g., error values less than zero) represent data samples for which the estimated corner weight underestimates (e.g., is less than) the corresponding measured corner weight, and positive error values (e.g., error values greater than zero) represent data samples for which the estimated corner weight overestimates (e.g., is greater than) the corresponding measured corner weight. In some examples, by estimating the corner weight using examples disclosed herein, the error between the estimated and measured corner weights is less than 20 kg.

In some examples, the vehicle weight estimation circuitry 102 includes means for obtaining data, means for calibrating, means for estimating weight, means for estimating location, means for outputting, and means for analyzing a map. For example, the means for obtaining data may be implemented by the data interface circuitry 902, the means for calibrating may be implemented by the calibration circuitry 904, the means for estimating weight may be implemented by the weight estimation circuitry 906, the means for estimating location may be implemented by the location estimation circuitry 908, the means for outputting may be implemented by the output circuitry 910, and the means for analyzing a map may be implemented by the map analysis circuitry 912. In some examples, the data interface circuitry 902, the calibration circuitry 904, the weight estimation circuitry 906, the location estimation circuitry 908, the output circuitry 910, and/or the map analysis circuitry 912 may be instantiated by programmable circuitry such as the example programmable circuitry 1512 of FIG. 15. Additionally or alternatively, the data interface circuitry 902, the calibration circuitry 904, the weight estimation circuitry 906, the location estimation circuitry 908, the output circuitry 910, and/or the map analysis circuitry 912 may be instantiated by any other combination of hardware, software, and/or firmware. For example, the data interface circuitry 902, the calibration circuitry 904, the weight estimation circuitry 906, the location estimation circuitry 908, the output circuitry 910, and/or the map analysis circuitry 912 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the vehicle weight estimation circuitry 102 of FIG. 1 is illustrated in FIG. 9, one or more of the elements, processes, and/or devices illustrated in FIG. 9 may be combined, divided, re-arranged, omitted, eliminated, and/or implemented in any other way. Further, the example data interface circuitry 902, the example calibration circuitry 904, the example weight estimation circuitry 906, the example location estimation circuitry 908, the example output circuitry 910, the example map analysis circuitry 912, the example database 914, and/or, more generally, the example vehicle weight estimation circuitry 102 of FIG. 9, may be implemented by hardware alone or by hardware in combination with software and/or firmware. Thus, for example, any of the example data interface circuitry 902, the example calibration circuitry 904, the example weight estimation circuitry 906, the example location estimation circuitry 908, the example output circuitry 910, the example map analysis circuitry 912, the example database 914, and/or, more generally, the example vehicle weight estimation circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example vehicle weight estimation circuitry 102 of FIG. 9 may include one or more elements, processes, and/or devices in addition to, or instead of, those illustrated in FIG. 9, and/or may include more than one of any or all of the illustrated elements, processes and devices.

Flowchart(s) representative of example machine readable instructions, which may be executed by programmable circuitry to implement and/or instantiate the vehicle weight estimation circuitry 102 of FIG. 9 and/or representative of example operations which may be performed by programmable circuitry to implement and/or instantiate the vehicle weight estimation circuitry 102 of FIG. 9, are shown in FIGS. 12 and/or 13. The machine readable instructions may be one or more executable programs or portion(s) of one or more executable programs for execution by programmable circuitry such as the programmable circuitry 1512 shown in the example processor platform 1500 discussed below in connection with FIG. 15 and/or may be one or more function(s) or portion(s) of functions to be performed by example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 12 and/or 13, many other methods of implementing the example vehicle weight estimation circuitry 102 may alternatively be used. For example, the order of execution of the blocks of the flowchart(s) may be changed, and/or some of the blocks described may be changed, eliminated, or combined.

Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 12 and/or 13 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 12 is a flowchart representative of example machine readable instructions and/or example operations 1200 that may be executed, instantiated, and/or performed by programmable circuitry to estimate one or more example weight metric(s) associated with the vehicle 100 of FIG. 1. The example machine-readable instructions and/or the example operations 1200 of FIG. 12 begin at block 1202, at which the example vehicle weight estimation circuitry 102 accesses and/or obtains one or more example calibration model(s) associated with the vehicle 100. For example, the calibration model(s) can be preloaded in the vehicle weight estimation circuitry 102 (e.g., in the database 914 of FIG. 9), and the example calibration circuitry 904 can access and/or obtain the calibration model(s) from the database 914. In some examples, the calibration circuitry 904 can generate the calibration model(s) based on input data (e.g., the sensor data 916, the scale data 918, and/or the user input 920 of FIG. 9) obtained by the example data interface circuitry 902 of FIG. 9. Generation of the calibration model(s) is described further below in connection with FIG. 13.

At block 1204, the example vehicle weight estimation circuitry 102 obtains example strain measurements from the strain gauges 114 of FIG. 1. For example, the data interface circuitry 902 obtains the sensor data 916 from the strain gauges 114 operatively coupled to respective different shock towers of the vehicle 100. In some examples, the sensor data 916 includes the strain measurements representing strain on surfaces of the respective shock towers.

At block 1206, the example vehicle weight estimation circuitry 102 estimates example corner weights of the vehicle 100 based on the strain measurements and the calibration model(s). For example, the example weight estimation circuitry 906 of FIG. 9 determines, based on the calibration model(s), corner weight(s) corresponding to the strain measurements for the respective wheels 104.

At block 1208, the example vehicle weight estimation circuitry 102 estimates a location (e.g., a center of mass location) of the load based on the estimated corner weights and corner curb weights. For example, the example location estimation circuitry 908 of FIG. 9 can obtain the corner curb weights from the calibration model(s) indicating the weight at the respective wheels 104 when the vehicle 100 is unloaded (e.g., when there are no passengers and/or cargo on the vehicle 100). Further, the location estimation circuitry 908 determines, based on differences between the estimated corner weights and the corresponding corner curb weights, example corner load weights corresponding to the respective wheels 104. In such examples, the corner load weights represent weight of the load on the vehicle (e.g., without the curb weight). Based on ratios between the corner load weights, the location estimation circuitry 908 estimates the load location with respect to a 2-D plane (e.g., a horizontal plane, a ground plane) of the vehicle 100.

At block 1210, the example vehicle weight estimation circuitry 102 selects example correction factors based on the estimated location. For example, the example map analysis circuitry 912 of FIG. 9 accesses (e.g., from the database 914) an example correction factor map generated and/or obtained for the vehicle 100. The correction factor map includes, for respective different locations of the load on the vehicle 100, correction factors to be applied to respective calibration model(s). In some examples, the map analysis circuitry 912 selects, from the correction factor map, the correction factors corresponding to the estimated load location.

At block 1212, the example vehicle weight estimation circuitry 102 determines updated corner weights based on the correction factors. For example, the map analysis circuitry 912 applies the selected correction factors to adjust gain values of the calibration model(s), then determines the updated corner weights based on the adjusted calibration model(s).

At block 1214, the example vehicle weight estimation circuitry 102 estimates a new location of the load based on the updated corner weights. For example, the location estimation circuitry 908 estimates the new location based on ratios between the updated corner weights.

At block 1216, the example vehicle weight estimation circuitry 102 calculates an example distance between the new location and the previous estimated location (e.g., the location estimated at block 1208). In some examples, the location estimation circuitry 908 calculates the distance between the new and previous locations along the 2-D plane of the vehicle 100.

At block 1218, the example vehicle weight estimation circuitry 102 determines whether the distance satisfies an example threshold (e.g., an error threshold). For example, the location estimation circuitry 908 determines that the distance satisfies the threshold when the distance is less than or equal to the threshold. In response to the location estimation circuitry 908 determining that the distance does not satisfy (e.g., is greater than) the threshold (e.g., block 1218 returns a result of NO), control returns to block 1210. Alternatively, in response to the location estimation circuitry 908 determining that the distance satisfies (e.g., is less than or equal to) the threshold (e.g., block 1218 returns a result of YES), control proceeds to block 1220.

At block 1220, the example vehicle weight estimation circuitry 102 estimates, based on the estimated corner weights, one or more example weight metrics associated with the vehicle 100. For example, the weight estimation circuitry 906 can estimate a GVW of the vehicle 100 based on a combination (e.g., an aggregate, a sum) of the estimated corner weights. Additionally or alternatively, the weight estimation circuitry 906 can estimate a weight of the load on the vehicle 100 (e.g., a load weight) based on a difference between the estimated GVW and a curb weight of the vehicle 100.

At block 1222, the example vehicle weight estimation circuitry 102 causes storage and/or presentation of one or more estimated weight metrics. For example, the example output circuitry 910 of FIG. 9 can provide the estimated metric(s) (e.g., including the estimated GVW, the estimated corner weights, and/or the estimated load weight) to the database 914 for storage therein. Additionally or alternatively, the output circuitry 910 can cause presentation of the estimated metric(s) via the user interface 116 of FIG. 1.

At block 1224, the example vehicle weight estimation circuitry 102 determines whether to continue monitoring. For example, the data interface circuitry 902 determines to continue monitoring when additional sensor data 916 is received and/or when the user input 920 includes a request to determine the one or more weight metrics. In response to the data interface circuitry 902 determining to continue monitoring (e.g., block 1224 returns a result of YES), control returns to block 1204. Alternatively, in response to the data interface circuitry 902 determining not to continue monitoring (e.g., block 1224 returns a result of NO), control ends.

FIG. 13 is a flowchart representative of example machine readable instructions and/or example operations 1300 that may be executed, instantiated, and/or performed by programmable circuitry to generate one or more example calibration models. The example machine-readable instructions and/or the example operations 1300 of FIG. 13 begin at block 1301, at which the example vehicle weight estimation circuitry 102 obtains and/or causes storage of initial strain measurements and/or corner curb weights associated with the respective wheels 104 of the vehicle 100. For example, the example data interface circuitry 902 of FIG. 9 obtains the initial strain measurements from one or more of the strain gauges 114 of FIG. 1 when no load is applied on the vehicle 100. The data interface circuitry 902 further obtains the corner curb weights based on the scale data 918 (e.g., representative of measured corner weights at the respective wheels 104). In some examples, the data interface circuitry 902 causes storage of the initial strain measurements in association with the corresponding corner curb weights as one or more example data samples in the database 914 of FIG. 9.

At block 1302, the vehicle weight estimation circuitry 102 detects and/or determines whether a load (e.g., a calibration load) is applied on the vehicle 100. For example, the example data interface circuitry 902 of FIG. 9 determines that the load is applied when new scale data 918 is received and/or based on the user input 920 to the user interface 116 of FIG. 1. In response to the data interface circuitry 902 determining that no load has been applied (e.g., block 1302 returns a result of NO), the data interface circuitry 902 continues to monitor incoming data (e.g., the scale data 918 and/or the user input 920) until a load is applied. Alternatively, in response to the data interface circuitry 902 detecting a load on the vehicle 100 (e.g., block 1302 returns a result of YES), control proceeds to block 1304.

At block 1304, the vehicle weight estimation circuitry 102 obtains example strain measurements from one or more of the strain gauges 114 of FIG. 1. For example, the data interface circuitry 902 obtains the strain measurements included in the sensor data 916 from respective ones of the strain gauges 114. In some examples, the strain measurements represent strain on respective shock tower surfaces on which the strain gauges 114 are mounted.

At block 1306, the vehicle weight estimation circuitry 102 obtains example measured corner weights based on the scale data 918 and/or the user input 920. For example, the data interface circuitry 902 obtains, based on the scale data 918 and/or the user input 920, the corner weights associated with respective wheels 104 of the vehicle 100 resulting from the applied load.

At block 1308, the vehicle weight estimation circuitry 102 causes storage of the strain measurements in association with the measured corner weights. For example, the data interface circuitry 902 provides the strain measurements and the corresponding measured corner weights to the database 914 of FIG. 9, where the strain measurements are stored in association with the measured corner weights as data samples corresponding to respective one(s) of the wheels 104.

At block 1310, the vehicle weight estimation circuitry 102 determines whether the number of data samples collected and/or stored in the database 914 satisfies an example threshold (e.g., a data sample threshold). In response to the data interface circuitry 902 determining that the number of data samples satisfies (e.g., is greater than or equal to) the threshold (e.g., block 1310 returns a result of YES), control proceeds to block 1314. Alternatively, in response to the data interface circuitry 902 determining that the number of data samples does not satisfy (e.g., is less than) the threshold (e.g., block 1312 returns a result of NO), control proceeds to block 1312.

At block 1312, the vehicle weight estimation circuitry 102 determines and/or detects whether the load has been adjusted (e.g., whether a weight of the load has been increased or decreased). In some examples, the data interface circuitry 902 determines that the load has been adjusted based on a change in the scale data 918 and/or based on the user input 920 indicating that the load has been adjusted. In response to the data interface circuitry 902 determining that the load has not been adjusted (e.g., block 1312 returns a result of NO), the data interface circuitry 902 continues to monitor the incoming data (e.g., the scale data 918 and/or the user input 920) until an indication that the load has been adjusted. Alternatively, in response to the data interface circuitry 902 determining that the load has been adjusted (e.g., block 1312 returns a result of YES), control returns to block 1304 to obtain one or more additional data samples.

At block 1314, the vehicle weight estimation circuitry 102 generates the calibration model(s) based on correlations between the strain measurements and the measured corner weights. For example, the example calibration circuitry 904 of FIG. 9 determines the correlations based on linear regression between the strain measurements and the corresponding measured corner weights included in the data samples, and generates the calibration model(s) based on the correlations. In some examples, the calibration model for a given wheel 104 includes a gain value (e.g., a slope) and an offset value (e.g., an intercept value, a y-intercept) representative of a linear relationship between the strain measurements and the corresponding corner weights at the wheel 104.

At block 1316, the vehicle weight estimation circuitry 102 causes storage of the calibration model(s). For example, the calibration circuitry 904 provides the calibration model(s) (e.g., the gain values and the offset values) to the database 914 of FIG. 9 for storage therein. In some examples, the calibration model(s) are accessible to the weight estimation circuitry 906 of FIG. 9 for use in estimating corner weight(s), load weight, and/or GVW of the vehicle 100.

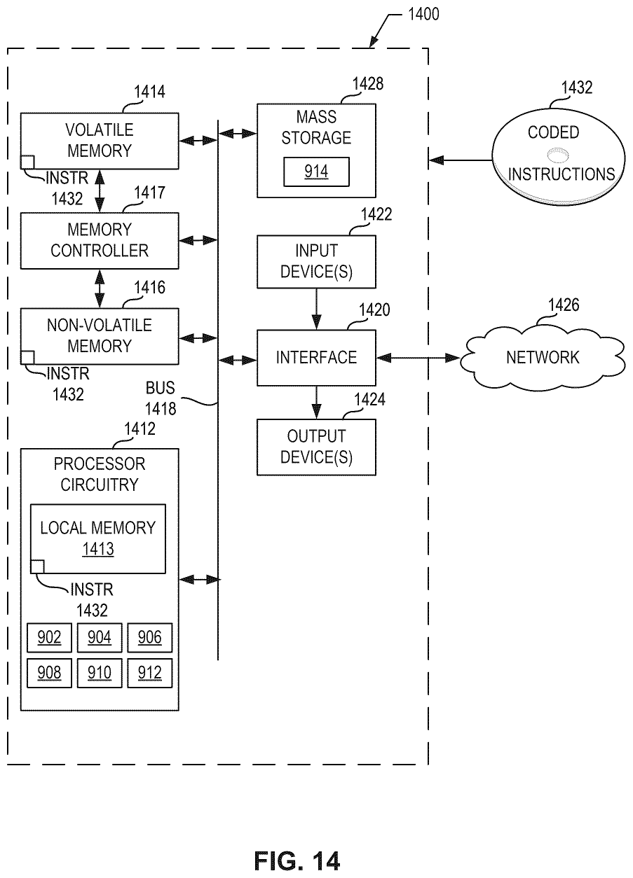

FIG. 14 is a block diagram of an example programmable circuitry platform 1400 structured to execute and/or instantiate the example machine-readable instructions and/or the example operations of FIGS. 12 and/or 13 to implement the vehicle weight estimation circuitry 102 of FIG. 9. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the example data interface circuitry 902, the example calibration circuitry 904, the example weight estimation circuitry 906, the example location estimation circuitry 908, the example output circuitry 910, the example map analysis circuitry 912, and/or the example database 914.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1432, which may be implemented by the machine readable instructions of FIGS. 12 and/or 13, may be stored in the mass storage device 1428, in the volatile memory 1414, in the non-volatile memory 1416, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that estimate load and/or weight of a vehicle. Examples disclosed herein estimate the load and/or weight based on strain measurements from one or more strain gauges operatively coupled to (e.g., mounted on) surfaces of respective shock towers of the vehicle. In some examples, by mounting the strain gauges on the respective shock towers, examples disclosed herein can obtain measurable (e.g., sufficiently large) and consistent strain measurements for use in the load and/or weight estimation. Further, strain gauges may be more robust to temperature changes and/or noise (e.g., noise resulting from hysteresis in one or more springs of a suspension system, sagging of the suspension system, bushing windup, etc.) compared to suspension-based sensors (e.g., position and/or displacement sensors operatively coupled to a suspension system of the vehicle). As a result, load and/or weight estimates based on the strain measurements associated with the shock tower may be more reliable and/or accurate compared to estimates using suspension-based techniques. By providing more accurate and/or reliable load and/or weight estimates, examples disclosed herein can prevent unintentional overloading of the vehicle and, as a result, may reduce a likelihood of deterioration of one or more components of the vehicle. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to estimate weight of a vehicle are disclosed herein. Further examples and combinations thereof include the following:

Example 1 includes an apparatus comprising interface circuitry, machine-readable instructions, and at least one processor circuit to be programmed by the machine-readable instructions to obtain strain measurement data from a strain gauge, the strain gauge coupled to a surface of a shock tower of a vehicle, estimate, based on the strain measurement data, a gross vehicle weight of the vehicle, and output the gross vehicle weight for presentation by a user interface.

Example 2 includes the apparatus of example 1, wherein the surface is a first surface, the strain gauge operatively coupled to the first surface via at least one mounting block, the at least one mounting block at least one of welded on or integrally formed in the first surface, the at least one mounting block to provide a second surface for the strain gauge.

Example 3 includes the apparatus of example 2, wherein a first strain measured by the strain gauge on the first surface of the shock tower is less than a second strain measured by the strain gauge on the second surface of the at least one mounting block, the strain measurement data representative of the second strain.

Example 4 includes the apparatus of example 1, wherein the surface corresponds to a top surface of the shock tower between fastener openings of the shock tower.

Example 5 includes the apparatus of example 1, wherein the surface corresponds to an inner surface of the shock tower, the inner surface to face a shock absorber coupled to the shock tower.

Example 6 includes the apparatus of example 1, wherein the surface corresponds to a side surface of the shock tower, the side surface extending downward from a top surface of the shock tower, the top surface including an opening for a shock absorber.

Example 7 includes the apparatus of example 1, wherein the strain gauge is a first strain gauge, the shock tower is a first shock tower, and wherein one or more of the at least one processor circuit is to obtain the strain measurement data from a second strain gauge coupled to a second shock tower of the vehicle, a third strain gauge coupled to a third shock tower of the vehicle, and a fourth strain gauge coupled to a fourth shock tower of the vehicle, the first, second, third, and fourth shock towers proximate respective wheels of the vehicle.

Example 8 includes the apparatus of example 7, wherein one or more of the at least one processor circuit is to estimate, based on the strain measurement data, corner weights corresponding to the respective wheels of the vehicle, estimate, based on the corner weights, a location with respect to a ground plane of the vehicle, the location corresponding to a center of mass of a load on the vehicle, select, from a map, correction factors based on the location, adjust the corner weights based on the correction factors, estimate the gross vehicle weight based on a sum of the adjusted corner weights, and output the gross vehicle weight for presentation by a user interface.

Example 9 includes the apparatus of example 8, wherein one or more of the at least one processor circuit is to estimate load weight of the load on the vehicle based on the gross vehicle weight and a curb weight of the vehicle.

Example 10 includes At least one non-transitory machine-readable medium comprising machine-readable instructions to cause at least one processor circuit to at least obtain strain measurement data from a strain gauge, the strain gauge coupled to a surface of a shock tower of a vehicle, and estimate, based on the strain measurement data, a gross vehicle weight of the vehicle.

Example 11 includes the at least one non-transitory machine-readable medium of example 10, wherein the surface is a first surface, the strain gauge operatively coupled to the first surface via at least one mounting block, the at least one mounting block at least one of welded on or integrally formed in the first surface, the at least one mounting block to provide a second surface for the strain gauge.

Example 12 includes the at least one non-transitory machine-readable medium of example 10, wherein the surface corresponds to a top surface of the shock tower between fastener openings of the shock tower.

Example 13 includes the at least one non-transitory machine-readable medium of example 10, wherein the surface corresponds to an inner surface of the shock tower, the inner surface to face a shock absorber coupled to the shock tower.

Example 14 includes the at least one non-transitory machine-readable medium of example 10, wherein the surface corresponds to a side surface of the shock tower, the side surface extending downward from a top surface of the shock tower, the top surface including an opening for a shock absorber.

Example 15 includes the at least one non-transitory machine-readable medium of example 10, wherein the strain gauge is a first strain gauge, the shock tower is a first shock tower, and wherein the machine-readable instructions are to cause one or more of the at least one processor circuit to obtain the strain measurement data from a second strain gauge coupled to a second shock tower of the vehicle, a third strain gauge coupled to a third shock tower of the vehicle, and a fourth strain gauge coupled to a fourth shock tower of the vehicle, the first, second, third, and fourth shock towers proximate respective wheels of the vehicle.

Example 16 includes the at least one non-transitory machine-readable medium of example 15, wherein the machine-readable instructions are to cause one or more of the at least one processor circuit to estimate, based on the strain measurement data, corner weights corresponding to the respective wheels of the vehicle, estimate, based on the corner weights, a location with respect to a ground plane of the vehicle, the location corresponding to a center of mass of a load on the vehicle, select, from a map, correction factors based on the location, adjust the corner weights based on the correction factors, and estimate the gross vehicle weight based on a sum of the adjusted corner weights.

Example 17 includes a method comprising obtaining strain measurement data from a strain gauge, the strain gauge coupled to a surface of a shock tower of a vehicle, estimating, based on the strain measurement data, a gross vehicle weight of the vehicle, and outputting the gross vehicle weight for presentation by a user interface.

Example 18 includes the method of example 17, wherein the surface is a first surface, the strain gauge operatively coupled to the first surface via at least one mounting block, the at least one mounting block at least one of welded on or integrally formed in the first surface, the at least one mounting block to provide a second surface for the strain gauge.

Example 19 includes the method of example 17, wherein the surface corresponds to a top surface of the shock tower between fastener openings of the shock tower.

Example 20 includes the method of example 17, wherein the surface corresponds to an inner surface of the shock tower, the inner surface to face a shock absorber coupled to the shock tower.

Example 21 includes the method of example 17, wherein the surface corresponds to a side surface of the shock tower, the side surface extending downward from a top surface of the shock tower, the top surface including an opening for a shock absorber.

Example 22 includes the method of example 17, wherein the strain gauge is a first strain gauge, the shock tower is a first shock tower, and wherein the machine-readable instructions are to cause one or more of the at least one processor circuit to obtain the strain measurement data from a second strain gauge coupled to a second shock tower of the vehicle, a third strain gauge coupled to a third shock tower of the vehicle, and a fourth strain gauge coupled to a fourth shock tower of the vehicle, the first, second, third, and fourth shock towers proximate respective wheels of the vehicle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
obtain strain measurement data from a strain gauge, the strain gauge coupled to a surface of a shock tower of a vehicle;
estimate, based on the strain measurement data, a gross vehicle weight of the vehicle; and
output the gross vehicle weight for presentation by a user interface.

2. The apparatus of claim 1, wherein the surface is a first surface, the strain gauge operatively coupled to the first surface via at least one mounting block, the at least one mounting block at least one of welded on or integrally formed in the first surface, the at least one mounting block to provide a second surface for the strain gauge.

3. The apparatus of claim 2, wherein a first strain measured by the strain gauge on the first surface of the shock tower is less than a second strain measured by the strain gauge on the second surface of the at least one mounting block, the strain measurement data representative of the second strain.

4. The apparatus of claim 1, wherein the surface corresponds to a top surface of the shock tower between fastener openings of the shock tower.

5. The apparatus of claim 1, wherein the surface corresponds to an inner surface of the shock tower, the inner surface to face a shock absorber coupled to the shock tower.

6. The apparatus of claim 1, wherein the surface corresponds to a side surface of the shock tower, the side surface extending downward from a top surface of the shock tower, the top surface including an opening for a shock absorber.

7. The apparatus of claim 1, wherein the strain gauge is a first strain gauge, the shock tower is a first shock tower, and wherein one or more of the at least one processor circuit is to obtain the strain measurement data from a second strain gauge coupled to a second shock tower of the vehicle, a third strain gauge coupled to a third shock tower of the vehicle, and a fourth strain gauge coupled to a fourth shock tower of the vehicle, the first, second, third, and fourth shock towers proximate respective wheels of the vehicle.

8. The apparatus of claim 7, wherein one or more of the at least one processor circuit is to:
estimate, based on the strain measurement data, corner weights corresponding to the respective wheels of the vehicle;
estimate, based on the corner weights, a location with respect to a ground plane of the vehicle, the location corresponding to a center of mass of a load on the vehicle;
select, from a map, correction factors based on the location;
adjust the corner weights based on the correction factors; and
estimate the gross vehicle weight based on a sum of the adjusted corner weights.

9. The apparatus of claim 8, wherein one or more of the at least one processor circuit is to estimate load weight of the load on the vehicle based on the gross vehicle weight and a curb weight of the vehicle.

10. At least one non-transitory machine-readable medium comprising machine-readable instructions to cause at least one processor circuit to at least:
obtain strain measurement data from a strain gauge, the strain gauge coupled to a surface of a shock tower of a vehicle; and
estimate, based on the strain measurement data, a gross vehicle weight of the vehicle; and
output the gross vehicle weight for presentation by a user interface.

11. The at least one non-transitory machine-readable medium of claim 10, wherein the surface is a first surface, the strain gauge operatively coupled to the first surface via at least one mounting block, the at least one mounting block at least one of welded on or integrally formed in the first surface, the at least one mounting block to provide a second surface for the strain gauge.

12. The at least one non-transitory machine-readable medium of claim 10, wherein the surface corresponds to a top surface of the shock tower between fastener openings of the shock tower.

13. The at least one non-transitory machine-readable medium of claim 10, wherein the surface corresponds to an inner surface of the shock tower, the inner surface to face a shock absorber coupled to the shock tower.

14. The at least one non-transitory machine-readable medium of claim 10, wherein the surface corresponds to a side surface of the shock tower, the side surface extending downward from a top surface of the shock tower, the top surface including an opening for a shock absorber.

15. The at least one non-transitory machine-readable medium of claim 10, wherein the strain gauge is a first strain gauge, the shock tower is a first shock tower, and wherein the machine-readable instructions are to cause one or more of the at least one processor circuit to obtain the strain measurement data from a second strain gauge coupled to a second shock tower of the vehicle, a third strain gauge coupled to a third shock tower of the vehicle, and a fourth strain gauge coupled to a fourth shock tower of the vehicle, the first, second, third, and fourth shock towers proximate respective wheels of the vehicle.

16. The at least one non-transitory machine-readable medium of claim 15, wherein the machine-readable instructions are to cause one or more of the at least one processor circuit to:
estimate, based on the strain measurement data, corner weights corresponding to the respective wheels of the vehicle;
estimate, based on the corner weights, a location with respect to a ground plane of the vehicle, the location corresponding to a center of mass of a load on the vehicle;
select, from a map, correction factors based on the location;
adjust the corner weights based on the correction factors; and
estimate the gross vehicle weight based on a sum of the adjusted corner weights.

17. A method comprising:
obtaining strain measurement data from a strain gauge, the strain gauge coupled to a surface of a shock tower of a vehicle;
estimating, based on the strain measurement data, a gross vehicle weight of the vehicle; and
outputting the gross vehicle weight for presentation by a user interface.

18. The method of claim 17, wherein the surface is a first surface, the strain gauge operatively coupled to the first surface via at least one mounting block, the at least one mounting block at least one of welded on or integrally formed in the first surface, the at least one mounting block to provide a second surface for the strain gauge.

19. The method of claim 17, wherein the surface corresponds to a top surface of the shock tower between fastener openings of the shock tower.

20. The method of claim 17, wherein the surface corresponds to an inner surface of the shock tower, the inner surface to face a shock absorber coupled to the shock tower.
